(19) United States
(12) Patent Application Publication
(10) Pub. No.: US 2011/0121114 A1
(43) Pub. Date: May 26, 2011

(54) MATERIAL MIXER WITH MULTI-FLIGHTED AUGER

(75) Inventors: RODNEY R. NEIER, DODGE CITY, KS (US); ALLIN L. BUTCHER, DODGE CITY, KS (US); ROSS M. GROENING, DODGE CITY, KS (US); MARK T. COOKSEY, GARDEN CITY, KS (US); CONWAY B. PRICE, ENSIGN, KS (US); JAMES E. SHAFER, DODGE CITY, KS (US)

(73) Assignee: ROTO-MIX, LLC, DODGE CITY, KS (US)

(21) Appl. No.: 12/624,748

(22) Filed: Nov. 24, 2009

(51) Int. Cl. B01F 7/24; B02C 21/02

(52) U.S. Cl. 241/101.8; 366/319; 366/297

(57) ABSTRACT

The invention relates to a mixer that includes at least one multi-flighted auger for mixing together materials, especially livestock feed. The multi-flighted auger rotates about a generally vertical axis. The flights include a kicker knife at the bottom and chopper knives around their periphery. The upper surface of the flights may be perpendicular to a shaft about which the auger rotates, or may be concave or slanted generally upwardly to encourage the material being mixed to remain in contact with the auger.

### FIELD OF THE INVENTION

The present invention relates generally to devices for mixing bulk materials, and more particularly to agricultural feed mixers with vertical augers.

### BACKGROUND OF THE INVENTION

Various types of agricultural mixers are known. One type of mixer, known as a vertical axis mixer, uses an open top tub that has one or more augers mounted for rotation about a vertical axis or axes. Each of the augers includes a flight that extends generally radially outwardly from an auger shaft. The flight forms a helical pattern around the auger shaft. Typically, the flight will taper from a relatively wide diameter at the bottom of the auger to a relatively narrow width near the top of the auger.

Ingredients such as hay, grain, silage, feed additives, molasses, animal fat, and other ingredients may be added into the tub through the open top end. The auger can then be rotated to mix the ingredients. Typically a door or similar opening or openings may be provided at or near the bottom of the tub to permit off-loading of the mixture after it has been mixed. The auger may be provided with knives or other sharp edges to chop the larger ingredients, such as hay. As the auger rotates, the material within the tub is drawn in by the bottom edge of the auger and rides up the helical surface of the auger flight to the top of the auger flight where it loses contact with the auger and falls back down towards the bottom of the tub under the force of gravity. This action tends to blend and mix the ingredients into a desired mixture, such as a feed mixture for livestock.

An example of a vertical axis mixer is shown in U.S. Pat. No. 5,462,354, the entire contents of which are hereby incorporated by reference. As is shown in the '354 patent, it is known to mount the vertical axis mixer on a trailer that can be pulled behind a tractor or other towing vehicle, or to mount the mixer on a self-propelled vehicle such as a truck.

As the auger rotates there is a resultant force applied to the auger by the ingredients being mixed. The loading on the auger tends to be uneven, which increases wear on the mixer, and can cause deflection of the mixer floor as the uneven forces tilt the auger from its normal vertical center line. This uneven loading of the auger may also produce unwanted vibration or shaking of the mixer and truck or trailer on which the mixer is mounted.

The mixture tends to come off the top of the auger in surges that match the highest portion of the flight as it rotates around the vertical axis. It would be desirable to even out or reduce this periodic surge.

Another difficulty encountered by vertical axis mixers is that some of the material being mixed, and in particular hay or stray, can become wedged between the lower surface of the flight and the floor of the mixer. This produces drag which tends to slow the rate at which the auger rotates at a given power input.

It is also desirable to reduce mixing time in order to more efficiently use an operator's time, and because prolonged exposure to the mixing action can damage some feeds.

### BRIEF SUMMARY OF THE INVENTION

Therefore, a primary object of the present invention is to provide an improved vertical axis mixer.

It is another object of the present invention to provide a vertical axis mixer that evens out the loading on an auger as it rotates.

It is another object of the present invention to provide a vertical axis mixer that has an increased mixing speed.

It is a further object of the present invention to provide a vertical axis feed mixer that reduces the problems associated with feed being wedged between the lower surface of an auger flight and the floor of the mixer tub.

It is a further object of the present invention to reduce shake and vibration produced by rotation of the augers in a vertical axis mixer.

It is another object of the present invention to provide a vertical axis mixer with a more even surge as the auger rotates.

According to one embodiment, the present invention is an agricultural mixer that has a tub which includes a bottom wall and generally upwardly extending side walls. A selectively rotatable mixing auger extends generally vertically upwardly from the bottom wall of the tub. The auger has a shaft that is rotatable about a generally vertical axis. The auger further includes a pair of helical flights extending radially outwardly from the shaft. The flights may taper from a relatively wide width at the bottom of the auger shaft to a relatively narrow width at the top of the shaft. A kicker may be mounted at a lower portion of the flight proximate to the bottom wall of the tub. The kicker may be mounted adjustably for movement radially inwardly and outwardly, and for adjustment up and down. Each of the flights may have an upper face that is concave. Each of the flights may have an outer edge that is higher than an inner edge attached to the auger shaft.

### BRIEF DESCRIPTION OF THE DRAWINGS

FIG. 1 is a side view of a mixer according to one embodiment of the present invention mounted on a trailer.

FIG. 2 is a side view of a mixer according to one embodiment of the present invention mounted on a self-propelled truck.

FIG. 3 is a top plan view of a mixer according to one embodiment of the present invention.

FIG. 4 is a partial cut-away side elevation view of the mixer tub of FIG. 3.

FIG. 5 is a perspective view of a double-flighted auger according to one embodiment of the present invention.

FIG. 6 is a side elevation view of the auger of FIG. 5.

FIG. 7 is a top view of the auger of FIG. 6.

FIG. 8 is a cross-sectional view taken along line 8-8 of FIG. 7.

FIG. 9 is a cross-sectional view of an auger according to one embodiment of the present invention, wherein the flights of the auger have a concave top surface.

FIG. 10 is a cross-sectional view of an auger according to another embodiment of the present invention wherein the flights of the auger have an outer edge that is higher than an inner edge.

FIG. 11 is a perspective view of a three-flighted auger according to one embodiment of the present invention.

FIG. 12 is a top plan view of the three-flighted auger of FIG. 11.

### DETAILED DESCRIPTION OF PREFERRED EMBODIMENTS

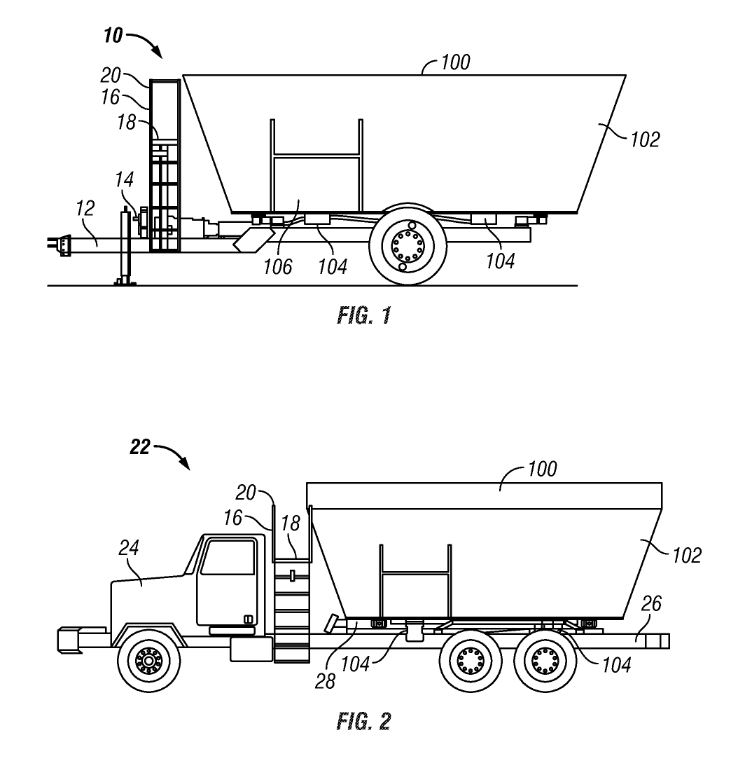

FIG. 1 shows a trailer 10 that includes mixer 100 according to one embodiment of the present invention. The trailer 10 includes a hitching tongue 12 for attachment to a towing vehicle (not shown) such as a tractor. A power takeoff connection 14 is provided to attach to the towing vehicle's power take off in order to provide power to the mixer 100. A ladder 16 is provided near a front end of the mixer 100.

The mixer 100 includes a tub 102 that is open on the top and provides a container for mixing livestock feed, or other materials. The mixer 100 includes at least one vertical auger (not shown) for rotation about a vertical axis to mix material added to the tub 102 into a desired mixture. Gear boxes 104 transmit power from the power takeoff to the augers. Those of ordinary skill in the art will be aware of many mechanisms for providing power to a rotatable auger within a mixer. A preferred variable speed transmission is disclosed in Neier, U.S. Pat. No. 5,462,354, the entire contents of which are hereby incorporated by reference, at a lower portion of the tub 102 to permit offloading of a mixture. The gate 106 may be selectively raised and lowered by a user. As an alternative to the gate 106 provided in the side of the tub 102 as shown in FIG. 1, a front or rear gate may be provided. Also conveyors or the like may be utilized in association with the gate to help in offloading and distributing the mixture. The ladder 16 includes an upper platform 18 and railing 20. The ladder 16 and platform 18 permit a user to view over the top edge of the tub 102 into the interior of the tub 100. The ladder 16 may also be useful in loading materials into the tub 102 for mixing.

FIG. 2 shows an embodiment of a truck 22 that includes a mixer 100 according to one embodiment of the present invention. The truck 22 has a cab 24 and a frame 26. The tub 102 of the mixer 100 is mounted on the truck frame 26. A drive line 28 provides power from an engine (not shown) within the truck cab 24 to gear boxes 104 that are part of the mixer 100. The gear boxes 104 transmit rotational power to the augers (not shown in FIG. 2) within the mixer 100. A ladder 16 is mounted on the truck frame 26 and includes a platform 18 and railing 20. The ladder 16 permits a user to view over the top edge of the tub 102 into the interior of the mixer 100. A gate 106 is provided at or near the bottom of the tub 102 to permit offloading of a mixture after it has been mixed. Those of ordinarily skill in the art will be aware of numerous mechanisms for attaching a mixer 100 to a truck 22 and for transmitting power to the augers.

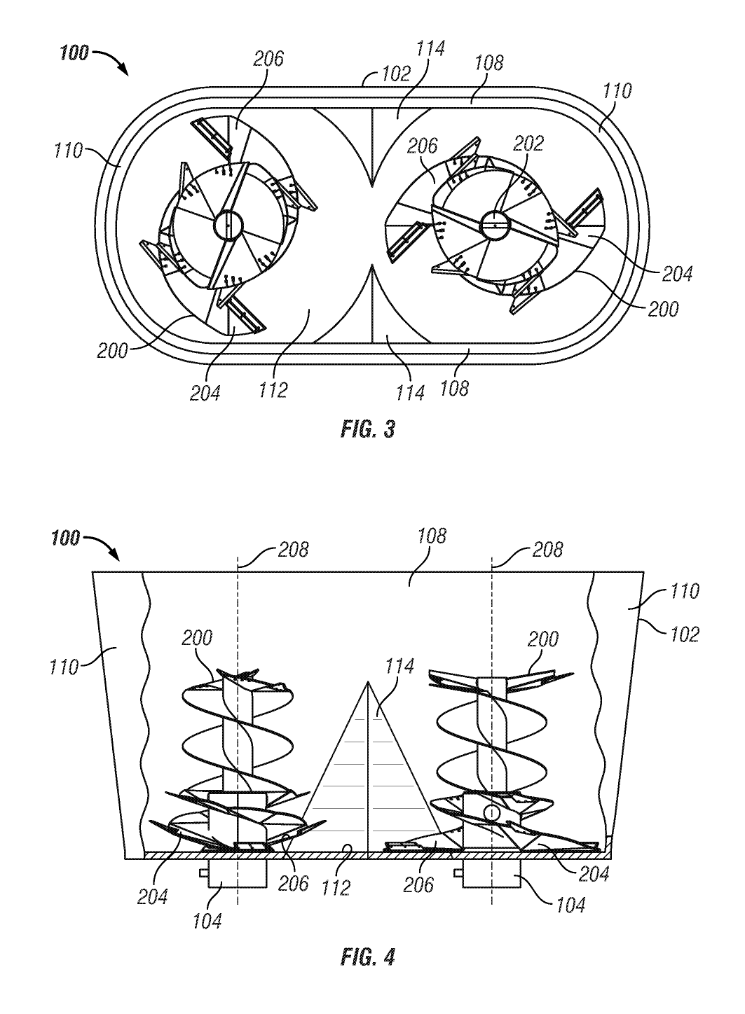

FIG. 3 is a top plan view of a mixer 100 according to one embodiment of the present invention. The mixer 100 includes a tub 102 that is open at the top and includes front and rear side walls 108 and end walls 110 that extend generally upwardly from a bottom wall 112. The walls 108 and 110 generally taper outwardly as they extend up from the bottom wall 112, such that the opening at the top of the tub 102 is larger than the bottom wall (floor) 112. Baffles 114 are provided along the insides of front and rear walls 108. The baffles 114 partially segregate the tub 102 into adjoining and continuous mixing chambers. Each of the mixing chambers is provided with an auger 200 for mixing materials. The baffles 114 serve to retain the material within an area that can be worked upon by the augers 200. Each of the augers 200 include a central shaft 202 from which a first flight 204 and a second flight 206 extend radially outwardly.

FIG. 4 shows a side view of the mixer 100 from FIG. 3 with a portion of the front wall 108 removed to show the interior of the tub 102. As can be seen in FIG. 4, each of the augers 200 is mounted for rotation about an axis 208 that is generally perpendicular to the floor 112 of the tub 102. Therefore, if the mixer 100 is level, for example if it is mounted on a truck that is sitting on flat ground, the augers 200 will rotate about generally vertical axes. Gear boxes 104 mounted beneath the bottom wall 112 transmit power to the augers 200. Those of ordinary skill in the art will appreciate that numerous other mechanisms may be used to provide rotational power to the augers 200. For example each of the augers could be provided with its own direct drive motor. The augers 200 could be driven by a chain drive. The mixer 100 should be appropriate for advantageous use by any number of drive mechanisms, and should not be limited to any particular type of drive. Therefore while the mixer 100 of FIG. 4 is shown without connection to any particular drive, it should be understood that to be operational a mixer 100 must be connected to some drive mechanism to rotate the augers 200.

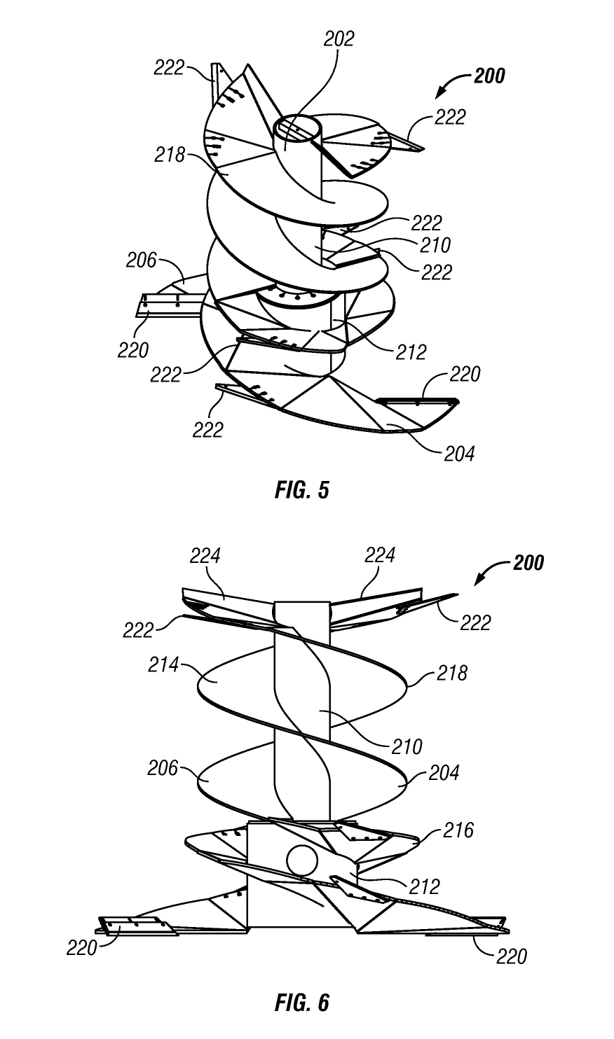

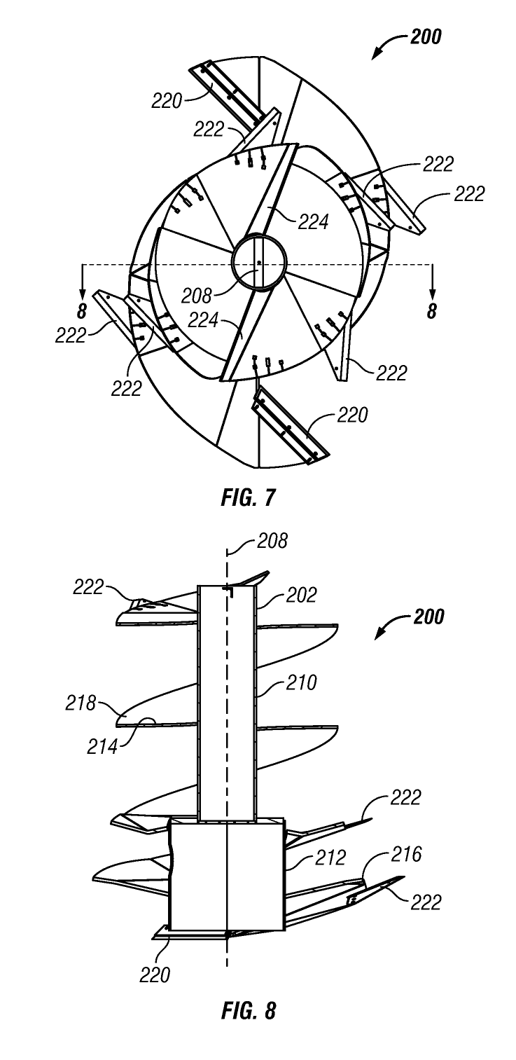

FIGS. 5-8 show an auger 200 according to one embodiment of the present invention. FIG. 5 is a perspective view of an auger 200. FIG. 6 shows the auger 200 from FIG. 5 in side view. FIG. 7 is a top plan view of the auger 200, and FIG. 8 is a cross-sectional view of the auger 200.

The auger 200 has a central shaft 202 that includes an upper portion 210 and a lower portion 212 that is stepped out to a wider diameter than the upper portion 210. The auger 200 includes a first flight 204 that winds around the shaft in a spiral pattern. In the embodiment shown, the flight 204 makes a little more than two complete 360° turns around the shaft 202. In the embodiment shown in FIGS. 5-8, the first flight 204 has an upper surface 214 that extends generally perpendicularly radially outwardly from the shaft 202. The perpendicular relationship of the upper surface 214 with respect to the shaft 202 can be best seen in the cross-sectional view of FIG. 8. The first flight 204 includes a lower portion 216 that extends outwardly from the lower portion 212 of shaft 202. The first flight 204 also includes an upper portion 218 that extends outwardly from the upper portion 210 of the shaft 202. The lower portion 216 of the first flight 204 tapers from a relatively wide diameter at its lowest extreme to a narrower diameter at its upper end, which terminates at the top of the lower portion 212 of the shaft 202. The upper portion 218 of the first flight 204 has a generally constant width from its lowest point where it meets up with the top of the lower portion 216 until very near the top of the shaft 202. The very top portion of the upper portion 218 tapers outward to a slightly wider width over the last approximately ⅛^{th} of a turn around the shaft 202. The pitch of the lower portion 216 of the first flight 204 is generally constant across its entire extent. The pitch of the upper portion 218 of the first flight 204 is also generally constant across its entire extent; however, the pitch of the upper portion 218 is a little steeper than the pitch of the lower portion 216, in order to quickly move the materials vertically.

In the embodiment shown in FIGS. 5-8, the second flight 206 is identical to the first flight 204, except that the second flight 206 is offset 180° from the first flight 204. Each of the flights 204, 206 includes a kicker knife 220 located at the very bottom of the flight 204 or 206. The kicker knife 220 has a sharp leading edge and is adjustable relative to the leading edge of the flight 204 or 206 to which it is attached. As best seen in FIG. 6, the leading edge of the knife 220 extends slightly below the lower most point of the flights 204 and 206. The kicker knife 220 serves to scrape, or nearly scrape the bottom wall 112 (see FIG. 4) of the tub 102. The trailing edge of the kicker knife 220 is slightly elevated relative to the upper surface 214 of the flights 204 and 206. As best seen in the top view of FIG. 7, the leading edge of the kicker knife 220 is angled generally inwardly from what would be a radial line from the axis of rotation 208 to the outer edge of the kicker knife 220. This inward angle of the kicker knife 220 serves to urge the material being mixed inwardly towards the axis of rotation 208 in order to help or encourage the material to remain in contact with the auger 200. Slots are provided in the flights 204 and 206, such that the kicker knives 220 can be adjusted to match the contour of the tub floor 112 (See FIG. 4). Preferably the kicker knives 220 will be adjusted so that their body edges very nearly touch the floor 112. This assures that the material does not wedge or get stuck below the augers 200.

Each of the flights 204 and 206 is also provided with a plurality of chopper knives 222. The chopper knives 222 extend generally radially outwardly from the outer edges of the flights 204 and 206. The chopper knives 222 have sharpened leading edges that are used to chop or break up hay or clumps of material that are being mixed. The leading, or sharpened edges of the chopper knives 222 are generally angled outwardly relative to an imaginary radius drawn between the axis of rotation 218 and the outer edges of the chopper knives 222. The knives 222 are adjustably mounted to the flights 204 and 206 by bolts or screws provided within slots formed in the flights 204 and 206. Those of skill in the art will be aware of numerous mechanisms for attaching the knives 220 and 222 to the flights 204 and 206, including but not limited to bolts, screws, and weldments.

Each of the flights 204 and 206 includes a kicker 224 that has a top edge that has a steeper pitch than the upper face 214 of the flight 204 and 206 to cause the material being mixed upwardly and outwardly away from the auger so that it can fall back to the bottom of the mixer 100.

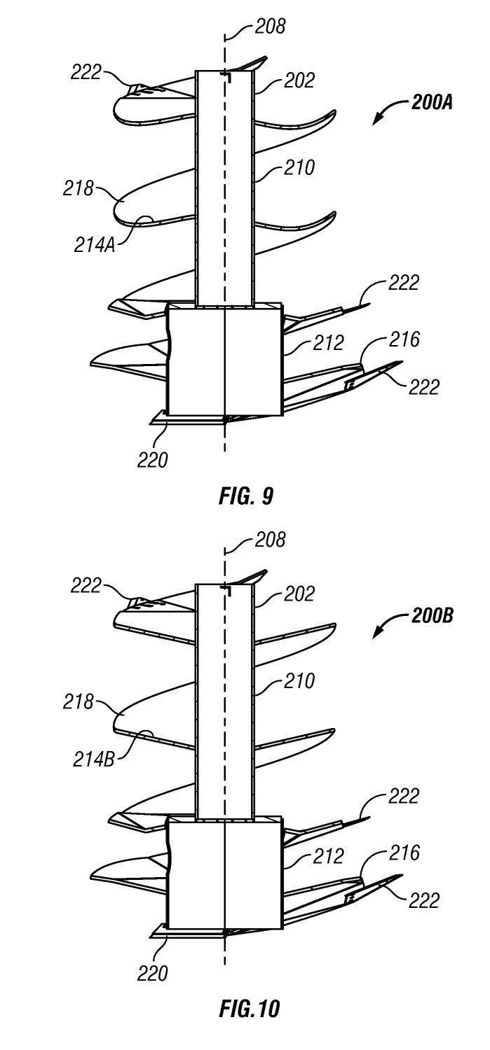

FIG. 9 shows a cross-sectional view of an alternative embodiment 200A of an auger according to the present invention. As seen in FIG. 9, the auger 200A has an upper surface 214A that is concave, rather than extending in a flat plane perpendicularly away from the shaft 202. This concave upper surface 214A urges, or encourages material being mixed to remain on the upper surface 214A, rather than sliding off radially outwardly off of the auger 200A.

FIG. 10 shows an alternative embodiment 200B of an auger according to one embodiment of the present invention. As seen in cross-sectional view of FIG. 10, the auger 200B includes flights 204 and 206 that have an upper surface 214B that extends generally upwardly from a relatively lower point where the flights 204 or 206 attaches to the shaft 202 to a relatively higher outer edge away from the shaft 202. This upwardly sloped upper face 214B also encourages material being mixed to remain on the auger 200B as it is rotated during a mixing operation.

The augers 200 will preferably be formed from a hard durable material such as steel or other metal. It may be desirable to form the kicker knives 220 and the chopper knives 222 from a harder metal so that they retain their sharpened edges. Those of ordinary skill in the art will be well aware of different materials and methods for forming the augers 200 described herein.

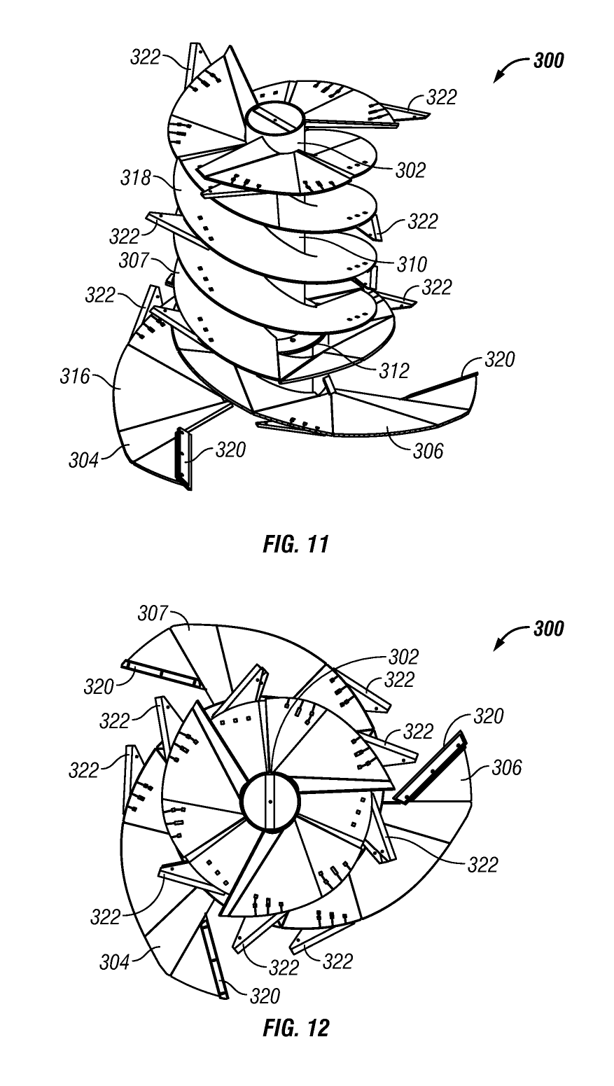

FIGS. 11 and 12 show a three-flighted auger 300 according to another embodiment of the present invention. FIG. 11 is a perspective view of the three-flighted auger 300. FIG. 12 is a top plan view of the auger 300 of FIG. 11.

The auger 300 has a central shaft 302 that includes an upper portion 310 and a lower portion 312 that is stepped out to a wider diameter than the upper portion 310. The auger 300 includes a first flight 304 that winds around the shaft 302 in a spiral pattern. In the embodiment shown, the first flight 304 makes a little more than two complete 360° turns around the shaft 302. The first flight 304 includes a lower portion 316 that extends radially outwardly from the lower portion 312 of the shaft 302. The first flight 304 also includes an upper portion 318 that extends radially outwardly from the upper portion 310 of the shaft 302. The lower portion 316 of the first flight 304 tapers from a relatively wide diameter at its lowest extreme to a narrower diameter at its upper end, which terminates at the top of the lower portion 312 of the shaft 302. The upper portion 318 of the first flight 304 has a generally constant width from its lowest point where it meets with the top of the lower portion 316 until very near the top of the shaft 302. The very top portion of the upper portion 318 tapers outwardly to a slightly wider width over the last approximately one-eighth of a turn around the shaft 302. The pitch of the lower portion 316 of the first flight 304 is generally constant across its entire extent. The pitch of the upper portion 318 of the first flight 304 is also generally constant across its entire extent; however, the pitch of the upper portion 318 is preferably a little steeper than the pitch of the lower portion 316 in order to quickly move the materials vertically when the auger 300 is being rotated.

The auger 300 includes three flights. Therefore, in addition to the first flight 304, it also includes a second flight 306 and a third flight 307 that extends radially outwardly from the shaft 302 in a helical pattern. Each of the flights 304, 306, and 307 are generally identical to each other, except that they are offset at equal intervals around the shaft 302. Since there are three flights in the embodiment of FIGS. 11 and 12, each flight is offset 120° from the adjacent flights. Additional flights may be added while still realizing the primary benefits of the present invention. Preferably, the flights will be evenly spaced around the shaft 302 so that the load on the auger 300 is generally equally distributed around the auger as it is rotated. Therefore, in a multiple flight auger that includes n number of flights, the angular offset of adjacent flights will preferably be determined by the operation 360/n degrees.

Each of the flights 304, 306 and 307 are provided with a kicker knife 320 at the lowermost and leading edge of the lower portion of the flights. Preferably, this kicker knife 320 will be adjustable to match the contours of the mixing compartment in which the auger is mounted. Each of the flights 304, 306 and 307 are also preferably provided with a plurality of chopper knives 322 to chop or breakup a material that is being mixed. In general, the description of the features of the two flighted augers 200, 200A, and 200B above will apply to the three flighted auger 300 shown in FIGS. 11 and 12, except that the three flighted auger 300 includes an additional flight.

In order to use a mixer 100 as described herein, a user should first visually inspect the mixer 100 to ensure that it is free from obstructions and appears to be in working order. The mixer 100 according to the present invention will typically be rated according to a maximum weight of material that can be mixed at any one time. A user should be careful not to overload the mixer. To begin the operation, the augers 200 should be rotated by engaging the augers 200 with a power source. For example, in FIG. 1, the PTO connection 14 should be attached to a power takeoff, and the gear box 104 should be adjusted to provide power to the augers 200. Those of ordinary skill in the art will be aware of numerous mechanisms for providing power to the augers 200. With the augers 200 running at idle speed, hay may be added to the tub 102 through the open top of the tub 102. After the hay is added, grain or other commodities may be added to tub 102. It is preferable to add any fragile ingredients as late in the loading sequence as possible. After the hay and grain has been added, high moisture products such as silage or green chop may be added to the tub 102. Finally, molasses, animal fat or liquid supplements may be added to the mixture last. The mixture should be allowed to remain in the tub 102 with the augers rotating for a few minutes, until a desired mixture is achieved. To offload a mixed mixture, the gate 106 may be opened to permit the mixture to be removed from the tub 102. For best results, it may help to spin the augers at a high RPM rate to ensure even flow and cleanout of the tub 102.

As the augers 200 rotate, the ingredients within the tub 102 will come in contact with the upper face 214 of the flights 204 and 206. Any ingredients that are on the floor 112 of the tub 102 will be scraped off by the leading edge of the kicker knives 220. By adjusting the leading edge of the kicker knives 220 to reduce or eliminate any gaps between the leading edge of the kicker knives 220 in the floor 112, drag that would normally occur when gaps are present as a result of hay or other ingredients becoming wedged between the bottom of the auger 200 and the floor 212 are eliminated. Furthermore, the inward angle of the leading edge of the kicker plate 220 directs the ingredients generally inwardly toward the center 208 of the auger 200, in order to encourage the ingredients to remain the area acted upon by the augers 200. The material will then generally ride up the flights 204 or 206 as the auger 200 rotates. When the material reaches the top of the auger 200, the kickers 224 tend to pop the material upwardly and outwardly away from the auger 200 so that it can drop back down to the bottom and be mixed some more. As the augers 200 spin, the chopper knives 222 come into contact with material that is outside the auger surface and breakup or chop that material.

Because the auger 200 includes two flights 204 and 206 that are generally identical and diametrically opposed to each other, the load on the shaft 202 tends to be generally even across any given diameter of the shaft 202. This is important because it reduces strain on the shafts 202, and upon the floor 112, which are normally subjected to uneven resultant forces as they augers 200 are rotated. As a further result, the tendency of the augers 200 to wobble about their axis of rotation 204 and produce vibration is reduced. This results in a smoother and quieter operation of the mixer 100. The rate at which the material is mixed is also increased. For each rotation of the auger 200 there is an increase in the amount of material being lifted by the flights 204 and 206 as compared to a single-flighted auger. This results in a more efficient and quicker mixing of materials. Single-flighted augers also tend to produce a periodic surge that results from the material falling off the top of the auger each time the top edge of the auger makes a rotation. By including two flights, the surge is evened out, because a top edge of a flight passes by a given spot twice during each rotation of the auger. This results in a more even unloading of material after the mixture has been mixed.

A preferred embodiment of the present invention has been set forth above. It should be understood by one of ordinary skill in the art that modifications may be made in many of the details discussed above, especially in matters of shape, size, and arrangement of parts. Such modifications are deemed to be within the scope of the present invention, which is to be limited only by the broad general meaning of the terms in which the appended claims are expressed.

What is claimed is:

1. An agricultural mixer comprising:
a tub having a bottom wall and generally vertically extending sidewalls; and
a mixing auger within the tub, the mixing auger having a shaft that is selectively rotatable about a generally vertical axis, the auger further including a pair of helical flights extending radially outwardly from the shaft, the flights being offset from each other.

2. The mixer of claim 1, further comprising a knife at a lower end of one of the pair of helical flights, the knife having a leading edge that is adjustable to match a contour of the bottom wall.

3. The mixer of claim 2, wherein the knife has a trailing edge that is spaced apart from a top surface of the one of the pair of helical fights to act as a kicker.

4. The mixer of claim 2, wherein the leading edge of the knife is angled inwardly relative to a direction of rotation to urge material being mixed towards the shaft.

5. The mixer of claim 1 further comprising a plurality of chopping knives mounted to the one of the flights, each of the chopping knives having a leading edge that is angled generally outwardly relative to a direction of rotation.

6. The mixer of claim 1, wherein the helical flights each have an upper surface that is concave.

7. The mixer of claim 1, wherein the helical flights each have an upper surface, wherein the upper surface slopes generally upwardly from the shaft to an outer edge of the upper surface.

8. The mixer of claim 1, wherein the shaft comprises a lower portion and an upper portion, and wherein the lower portion is stepped outwardly from the upper portion.

9. The mixer of claim 8, wherein each of the flights includes a lower portion mounted to the lower portion of the shaft and an upper portion mounted to the upper portion of the shaft, and further wherein the upper portion of each of the flights has a steeper pitch than the lower portion of the flights.

10. The mixer of claim 1, wherein the flights are offset from each other by 180°.

11. The mixer of claim 1, wherein the auger further comprises a third helical flight extending radially outwardly from the shaft.

12. A mixing auger for use in a vertical axis agricultural mixer, the mixing auger comprising:
a shaft;
a first helical flight extending radially outwardly from the shaft; and
a second helical flight extending radially outwardly from the shaft.

13. The mixing auger of claim 12, further comprising:
a first knife at a lower end of the first helical flight, the first knife having a leading edge that is adjustable relative to the first flight; and
a second knife at a lower end of the second helical flight, the second knife having a leading edge that is adjustable relative to the second flight.

14. The mixing auger of claim 13, wherein the first knife has a trailing edge that is spaced apart from a top surface of the first helical flight and the second knife has a trailing edge that is spaced apart from the top surface of the second helical flight.

15. The mixing of claim 13, wherein the leading edges of the first and knives are angled inwardly.

16. The mixing auger of claim 12 further comprising a plurality of chopping knives mounted to the first and second flights, each of the chopping knives having a leading edge that is angled generally outwardly.

17. The mixing auger of claim 12, wherein the helical flights each have an upper surface that is concave.

18. The mixing auger of claim 12, wherein the helical flights each have an upper surface, wherein the upper surface slopes generally upwardly from the shaft to a portion radially outward from the shaft.

19. The mixing auger of claim 12, wherein the shaft comprises a lower portion and an upper portion, and wherein the lower portion is stepped outwardly from the upper portion.

20. The mixing auger of claim 19, wherein each of the flights includes a lower portion mounted to the lower portion of the shaft and an upper portion mounted to the upper portion of the shaft, and further wherein the upper portion of each of the flights has a steeper pitch than the lower portion of the flights.

21. The mixing auger of claim 12, further comprising a third helical flight extending radially outwardly from the shaft.

22. An agricultural mixer, comprising:
a tub;
a mixing auger within the tub, the mixing auger having a shaft that is rotatable about a generally vertical axis, the auger further including n helical flights extending radially outwardly from the shaft, wherein n≧2, and wherein each helical flight is offset from an adjacent flight by an angle of 360/n degrees.

23. The agricultural mixer of claim 22, further comprising a second mixing auger within the tub, the second mixing auger having a second shaft that is rotatable about a second generally vertical axis, the second mixing auger including a second mixing auger helical flight extending radially outwardly from the second shaft.
